(19) United States
(12) Patent Application Publication
(10) Pub. No.: US 2005/0072317 A1
(43) Pub. Date: Apr. 7, 2005

(54) Device for forming piecrust blanks

(76) Inventor: Richard D. Thorstad, Aurora, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 10/678,581

(22) Filed: Oct. 2, 2003

(51) Int. Cl. A47J 43/18

(52) U.S. Cl. 99/450.1

(57) ABSTRACT

A device for facilitating manual formation of dough for use in piecrusts, tortillas, and the like includes a base ring having an aperture therethrough of a size and shape corresponding to a piecrust blank to be formed therein. A first inner ring may be positioned in the aperture through the base ring with the first inner ring having an outer periphery substantially the same as the aperture through the base ring and an inner periphery of a size commensurate with a smaller desired pie crust blank. A second inner ring having an outer periphery commensurate in size and shape to the inner periphery of the first inner ring may be positioned within the first inner ring with the second inner ring having an aperture therethrough of a size and configuration commensurate with an even smaller piecrust blank to be formed therein. The base ring as well as the first and second inner rings are of a predetermined thickness commensurate with the thickness of the piecrust blank to be formed in the device.

### BACKGROUND OF THE INVENTION

1. Field of the Invention

The present invention relates generally to forming or rolling dough for use as a piecrust, tortilla, or the like, and more particularly to a device wherein blanks of dough can be formed of a predetermined size, shape and thickness by rolling the dough in the device which has a predetermined thickness and configuration desired for the blanks of dough.

2. Description of the Relevant Part

Piecrusts, tortillas, and the like are typically formed by taking a quantity of dough and placing it on a flat surface where it can be rolled and spread to a predetermined thickness by use of a hand roller. Hand rollers typically have a main cylindrical body with handles at opposite axial ends which are rotatably connected to the main body so that an individual can grasp the handles and roll the cylindrical body back and forth across the dough until it is flattened to the desired thickness. As will be appreciated, it is difficult to obtain a uniform thickness and further it is difficult to obtain a predetermined thickness which is ideal for piecrust blanks, tortillas, or the like. It is also difficult to form the blanks of dough in a perfect circle, as is usually desired, and accordingly the dough, in the case of a piecrust blank, after it has been rolled typically is placed into a pie pan or the like and excess dough is removed by hand from around the edges of the pan.

It is evident it would be desirable to have a system or device by which dough used in the formation of piecrusts, tortillas, and the like could be uniformly rolled to a desired size, configuration and thickness.

Devices have been developed and marketed for obtaining a uniform thickness of the dough and in one such system, rings having an internal diameter commensurate with the outer diameter of the main body of a hand roller are removably positioned near the ends of the main body of the roller. The outer diameter of the rings is predetermined depending on the thickness desired for the dough. As will be appreciated, when the roller is rolled on a support surface on which the dough is being formed into the desired thickness for a piecrust, the rings maintain the main body of the roller at a predetermined spacing from the support surface which is commensurate with the thickness desired for the rolled dough.

Another device for a obtaining uniform thickness in dough used in piecrusts utilizes a quadrilateral base on which the dough can be rolled and wherein a raised rim is provided around the edges of the quadrilateral base with the height of the rim being adjustably commensurate with the desired thickness of the piecrust. A relatively large roller is used which can roll along the raised rim of the device so that the roller is uniformly spaced from the base and the dough is thereby rolled into a uniform thickness.

An obvious drawback with either of the systems described above resides in the fact that while the dough can be formed into a predetermined and desired thickness, it is not necessarily formed into the desired circular configuration for use in a circular pie pan. Accordingly, even though the dough is of uniform thickness when it is placed in the pie pan, an individual still needs to remove excess dough from around the edges of the pie pan or add additional dough before the dough is further processed in the preparation of a pie.

From the above it will be appreciated a need for a device for rolling dough into a predetermined size, shape and thickness would be desirable and it is to this end that the present invention has been developed.

### SUMMARY OF THE INVENTION

A device for uniformly forming circular piecrust blanks, tortillas, and the like of a predetermined size configuration and thickness includes a base or outer ring having an aperture with a diameter of a maximum size that may be desired for a piecrust. Additional inner rings of decreasing inner diameters are positioned within the aperture of the outer or base ring and the inner rings are removable. Each successively smaller inner ring has an outer diameter commensurate with the diameter of the aperture of the next adjacent outer ring and an inner diameter of a size that might be desired for a piecrust. Any number of inner rings can be utilized so that when each successively smaller ring is positioned within the outer base ring, smaller openings are effectively provided through the base ring in which the dough for a piecrust can be rolled.

The base ring and the inner rings are all of the same uniform thickness which is consistent with the thickness desired for the pie dough.

A roller is used to convert a quantity of dough to a flat, circular blank of dough of uniform thickness by placing the dough within the aperture of the innermost ring being utilized and rolling the roller over the top surface of the rings which are positioned on a support surface on which the dough is rolled.

As will be appreciated, after the dough has been rolled until it is of a thickness commensurate with the thickness of the rings, it can be removed from the device, even though if any excess dough overlaps the edge of the innermost ring, that dough can be easily cut with a knife or torn away with one's fingers so that the resultant rolled dough is of the desired thickness, size and configuration for use in making a pie.

While the present disclosure is made by reference to forming piecrust blanks, it will be appreciated the invention is applicable to other similar products such as tortillas and the like.

Other aspects, features and details of the present invention can be more completely understood by reference to the following detailed description of a preferred embodiment, taken in conjunction with the drawings and with the appended claims.

### A BRIEF DESCRIPTION OF THE DRAWINGS

FIG. 1 is a top plan view of the device of the present invention.

FIG. 2 is an isometric view of the device shown in FIG. 1.

FIG. 3 is an exploded isometric view similar to FIG. 2.

FIG. 4 is a fragmentary isometric view of the device of the present invention positioned on a support surface and with a quantity of dough and roller positioned for forming a blank of dough in a desired piecrust configuration.

FIG. 5 is a fragmentary isometric view similar to FIG. 4, wherein the dough has been partially spread within the device.

FIG. 6 is an isometric with the dough having been fully formed into the desired circular configuration and the device having been removed from the support surface on which the blanks of dough is positioned.

### DESCRIPTION OF THE PREFERRED EMBODIMENT

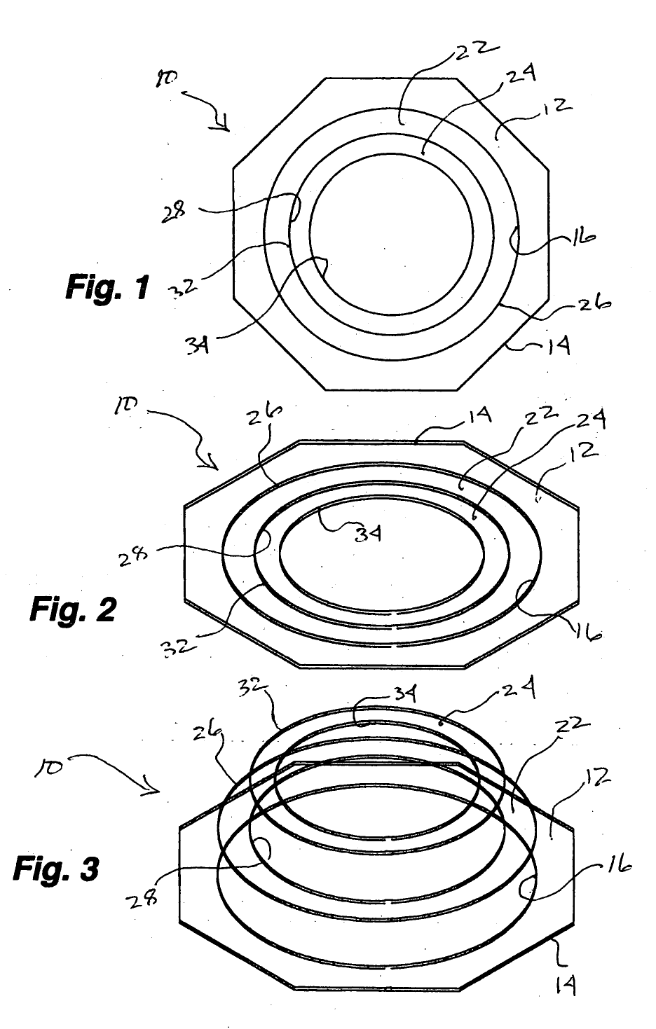

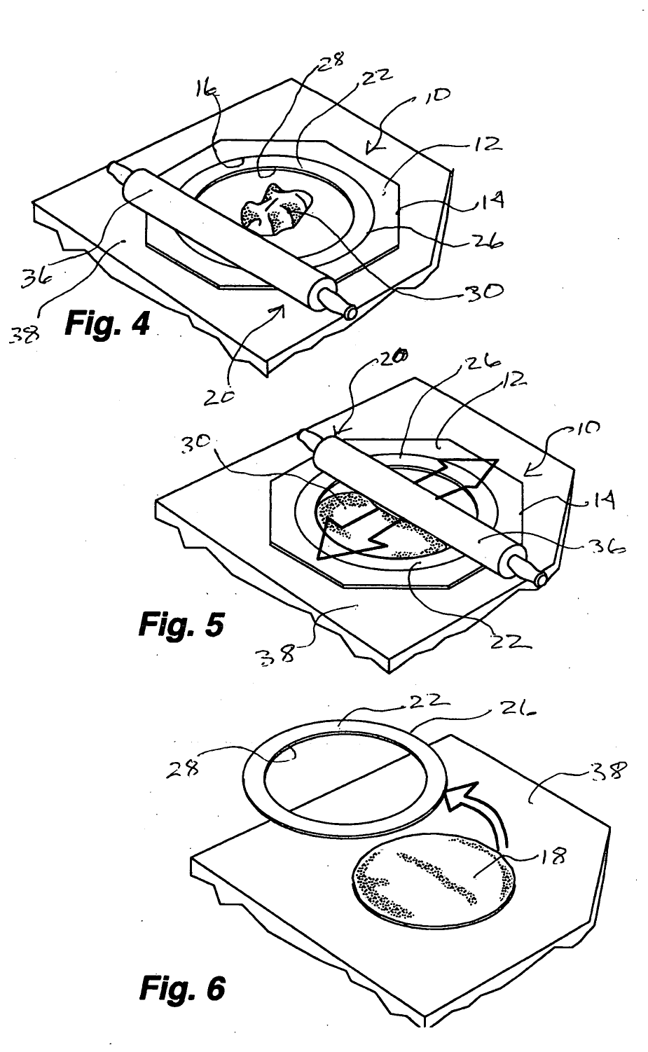

With reference first to FIGS. 1-3, the device 10 of the present invention can be seen to include an outer base ring 12 having an octagonal outer periphery 14 and a central aperture 16 of circular configuration and of a first predetermined diameter. The first predetermined diameter is commensurate with that of the largest piecrust blank 18 (FIG. 6) which might be desired to be made in the device. The outer periphery 14 can be of any desired configuration with the octagonal periphery being only illustrative. The only important relationship between the outer periphery and the central aperture 16 is that the surface area around the aperture 16 be sufficient to support a roller 20 (FIGS. 4-6) used to form the dough within the device 10. The thickness of the device is also important as it is commensurate with the desired thickness for the pie crust blank 18 to be formed in the device. The base ring 12 can be made of any suitable material but preferably the material is rigid and lightweight and is of a size that can be conveniently stored in a kitchen cabinet or the like.

A large 22 and a small 24 inner ring are positionable within the base ring 12 with the large inner ring having an outer diameter or periphery 26 substantially commensurate with the diameter of the aperture 16 through the base ring 12. The inner diameter of the large inner ring defines an aperture 28 of a size commensurate with the diameter of a smaller piecrust blank that may be desired. As will be appreciated, if the large inner ring is positioned within the base ring, a quantity of dough 30 (FIG. 4) can be positioned within the aperture 28 defined by the inner diameter of the large inner ring and the portion of the device outwardly of the aperture 28 will serve as a support for the roller 20 used in forming the piecrust blank 18.

The small inner ring 24 has an outer diameter or periphery 32 substantially the same as the aperture 28 of the large inner ring 22 and an inner diameter defining an aperture 34 commensurate with the size of an even smaller piecrust blank that might be desired to be made in the device. As will be appreciated, the small-inner ring 24 can be positioned within the large inner ring 22 to define a circular area in which the pie dough 30 can be rolled into the desired size, shape and thickness. Again, the portion of the device outwardly from the aperture 34 through the small inner ring serves as a support surface for the roller when forming the pie dough within the small inner ring.

The base ring 12 and the inner rings 22 and 24 are shown exploded in FIG. 3 and as will be appreciated the material illustrated for the rings is transparent even though it is evident that materials of any transparency could be utilized.

With reference to FIG. 4, the device 10 is shown in a preliminary setup prior to being used to form a quantity of dough 30 into a size, shape and thickness for use as a piecrust blank 18 where the desired diameter of the piecrust is commensurate with the size of the aperture 28 in the large inner ring. As illustrated in FIG. 5, the roller 20 is rolled back and forth across the dough while being supported on the base ring 12 and the large inner ring 22 so that the main body 36 of the roller is uniformly spaced from the support surface 38 underlying the device and on which the piecrust dough 30 is positioned. The piecrust dough is formed beneath the roller until it fully fills the aperture 28 defined through the large inner ring 22 as shown in FIG. 6 and then the base ring 12 and large inner ring are removed leaving the perfectly formed piecrust dough blank 18 of the predetermined size, shape and thickness on the support surface. If the piecrust dough overruns the edge along the periphery of the aperture 28 of the large inner ring, it can simply be cut with a knife or pulled away with one's fingers so that the only dough remaining is that within the confines of the large inner ring 22.

Although the present invention has been described with a certain degree of particularity, it is understood the disclosure has been made by way of example, and changes in detail or structure may be made without departing from the spirit of the invention as defined in the appended claims.

1. A device for facilitating the formation of a blank of dough into a predetermined size, shape and configuration comprising in combination:
a base ring having an outer periphery and an inner aperture therethrough with the aperture being configured to correspond with the desired size and configuration of the blank to be formed in the device, the base ring having a thickness corresponding to the thickness desired for the blank.

2. The device of claim 1 further including a first inner ring having an outer periphery substantially conforming to the periphery of the aperture through the base ring and having an aperture therethrough commensurate in size and shape to a blank of dough to be formed in the device.

3. The device of claim 2 further including a second inner ring having an outer periphery corresponding generally to the size and configuration of the aperture through the first inner ring and having an aperture therethrough of a size and configuration commensurate with a blank of dough to be formed therein.

4. The device of claim 3 wherein the thickness of the first and second inner rings is the same as the thickness of the base ring.

5. The device of claim 4 wherein the aperture through the base ring, the first inner ring and the second inner ring are all circular in configuration.
